(19) United States
(12) Patent Application Publication
(10) Pub. No.: US 2007/0056179 A1
(43) Pub. Date: Mar. 15, 2007

(54) Angle reading and setting mechanism

(76) Inventor: Jerrold Beall, Newark, OH (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/393,990

(22) Filed: Mar. 30, 2006

Related U.S. Application Data
(60) Provisional application No. 60/718,423, filed on Sep. 19, 2005.

(51) Int. Cl. B23Q 17/22

(52) U.S. Cl. 33/640

(57) ABSTRACT

Electronic device for reading and setting angles. An electronic angle or position sensing mechanism is mounted together with appropriate circuitry, controls and a digital readout in a small housing having a base and at least one side, and preferably two sides, oriented at right angles to the base. A relatively powerful permanent magnet, such as a rare earth magnet, is fixed in each housing side so that the entire device can be temporarily attached to a ferromagnetic metal surface with one of the magnet-containing housing walls in firm contact with that metal surface, such as the side of a circular saw blade or a machine fence.

### REFERENCE DATA

This patent claims priority to U.S. Provisional patent application Ser. No. 60/718,423 filed Sep. 19, 2005, which is incorporated herein by reference.

### FIELD OF THE INVENTION

This invention relates to protractors, angle gauges and other devices for determining the angle between two surfaces, such as a table saw blade and the table surface, or for establishing a specific desired such angle between two surfaces.

### BACKGROUND OF THE INVENTION

Accurate determination of the angle between two surfaces is frequently important in a wide variety of endeavors, including woodworking, among many others. For instance, in the course of woodworking, it is frequently important to establish one work piece surface at a particular angle relative to another surface of the same work piece. The desired angle is often 90 degrees, which typically is fairly easy to do because woodworking machinery usually is configured to repeatedly cut or form such work piece surfaces at rights angles. Establishing other work piece surface angles is more difficult, particularly with accurate repeatability. This is because, among other reasons, the scales provided on woodworking tools such as table saws and jointers often cannot be read accurately, and usually no stops are available to facilitate setting non-typical angles, such as angles that are not 45 or 90 degrees.

such other angles are needed, for instance, when a picture frame, glued-segment bowl blank or other such multi-component assembly utilizes five or more segments.

As a result there is a need for a more accurate, easier to use, repeatable means for setting and reading angles on woodworking tools like table saws, jointers and other tools and machinery.

### SUMMARY OF THE INVENTION

This invention is a small, convenient, easily used, inexpensive electronic device for reading and setting angles. An electronic angle or position sensing mechanism is mounted together with appropriate circuitry, controls and a digital readout in a small housing having a base and at least one side, and preferably two sides, oriented at right angles to the base. A relatively powerful permanent magnet, such as a rare earth magnet, is fixed in each housing side so that the entire device can be temporarily attached to a ferromagnetic metal surface with one of the magnet-containing housing walls in firm contact with that metal surface, such as the side of a circular saw blade or a machine fence.

The mechanism can be used, for instance, by positioning it upright on a table saw table top, horizontal surface. After turning it “on” with the “on/off” button, pushing the “zero” button “zeros” the unit, making it read “0” degrees. The unit can then be attached to the saw blade using one of the magnets. At this point it will read the angle of the saw blade (or that angle plus or minus 90 degrees) relative to the table top by reference to which it was “zeroed,” providing that angle without regard to whether the saw table top was actually level. The saw blade angle can be adjusted using the table saw tilt mechanism in the normal way while reading the angle showing on the LED readout.

### BRIEF DESCRIPTION OF THE DRAWINGS

FIG. 1 is an front view of an exemplary embodiment of the angle reading and setting apparatus of this invention.

FIG. 2 is a side view of the apparatus shown in FIG. 1.

FIGS. 3A and 3B are schematic diagrams of an exemplary circuit for use in practicing this invention.

FIG. 4 is a functional block diagram of an exemplary position sensing device usable in the apparatus of this invention.

FIG. 5 is an alternative embodiment of this invention using a cruciform housing.

FIGS. 6 and 7 are schematic front views of a table saw with the angle reading and setting apparatus of this invention positioned on the table top in FIG. 6 and attached to the blade in FIG. 7.

### DETAILED DESCRIPTION

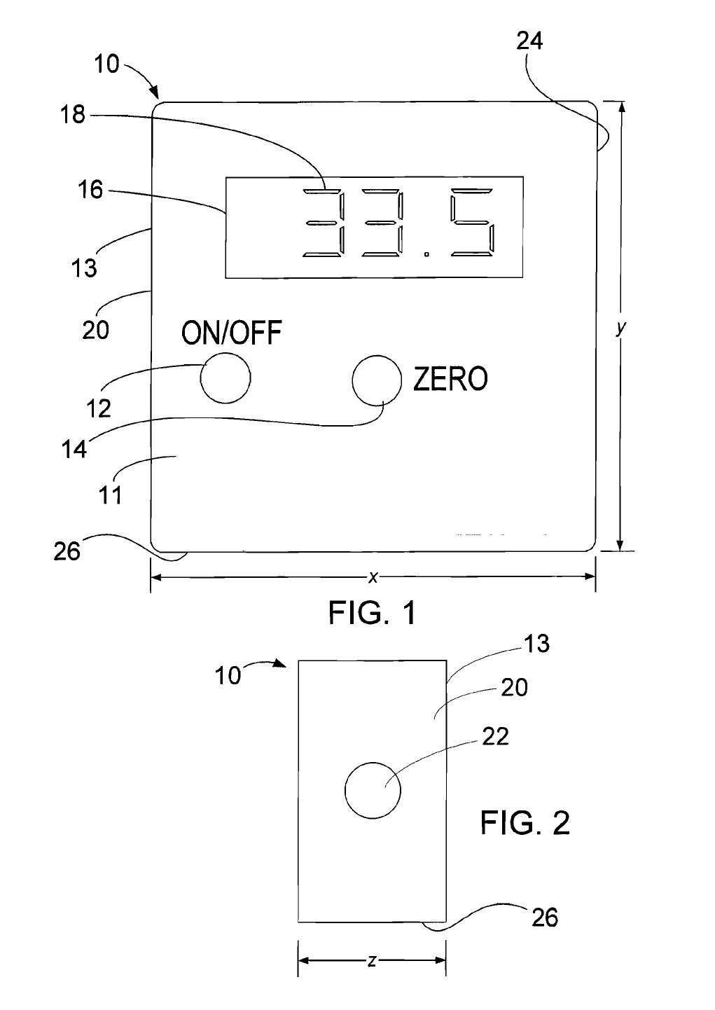

FIG. 1 is an enlarged front view of one embodiment of the angle reading and setting apparatus 10 of this invention. Positioned on the front 11 of housing 13, the on/off button 12, “zero” button 14, and the window 16 through which numerals 18 may be seen on an LED display.

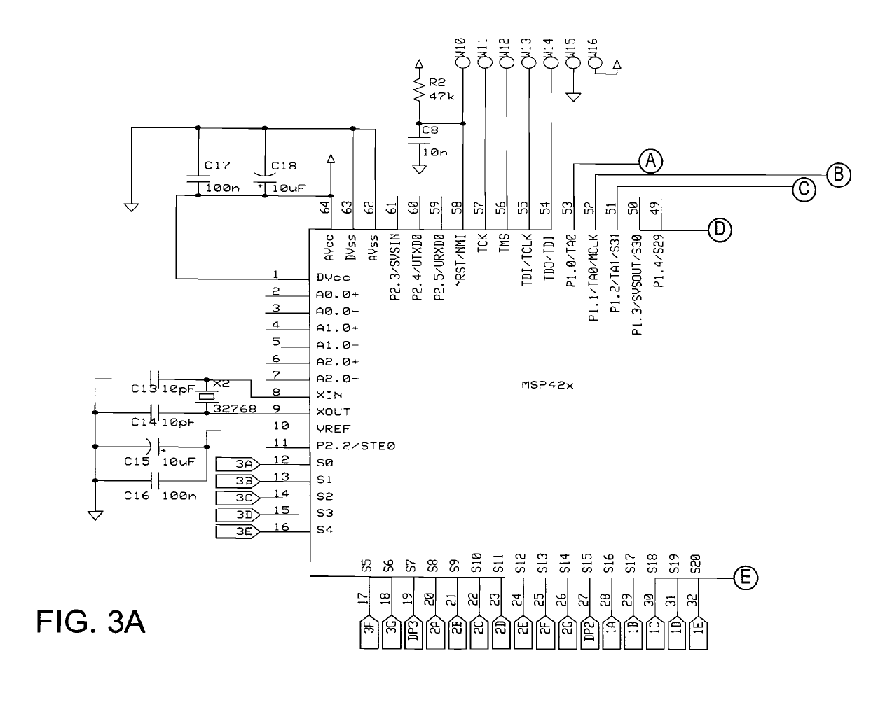

FIG. 2 is a side view of the apparatus 10 showing side 20 of housing 13 with a round rare earth magnet 22 fixed (for instance with glue or liquid thread locker such as Locktite brand thread locker) in the side 20 and flush with its surface. Alternatively, the magnets 22 can be mounted slightly below the surface of each side 20 to insure that side 20 will seat solidly against any ferromagnetic surface it contacts. As is apparent from FIG. 1, the sides 20 and 24 of housing 13 are “square” to its bottom 26 (i.e., sides 20 and 24 form a 90° angle with bottom 26). In the embodiment of this invention illustrated in the Figures, the front 13 is square to both the sides 20 and 24 and the bottom 26. This arrangement works well but is not required. The front 13 could slope back from the bottom, which would facilitate viewing the readout in certain situations, and the front 13 could also form other than a ninety degree angle with the sides 20 and 24. Moreover, the front 13 need not be flat. Other configurations could also be used, including ones in which one or both of the readout opening 16 and the controls 12 and 14 could be mounted on the top or back of the apparatus 10. It is desirable, however, for the apparatus 10 to have a bottom that will register with a horizontal surface to make position readings relative to that surface. It is likewise desirable for the apparatus 10 to have at least one magnet-containing side surface that is square to the bottom (forms a ninety degree angle with the bottom) and that will register with a planar ferromagnetic surface to which the apparatus can be attached with the magnet.

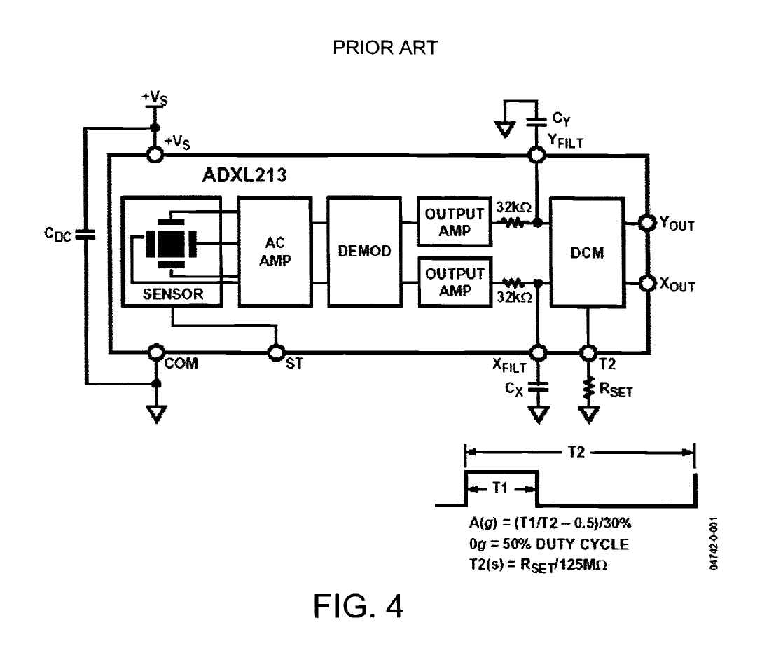

Mounted inside housing 13 is sensitive position-sensing circuitry and a battery to power the circuitry. Numerous devices and circuitry could be used to provide the needed position-sensing functionality for this invention. In the embodiment illustrated in the figures, an ADXL213 Dual Axis Accelerometer with Duty Cycle Modulated Outputs is utilized, which has the functional block diagram shown in FIG. 4.

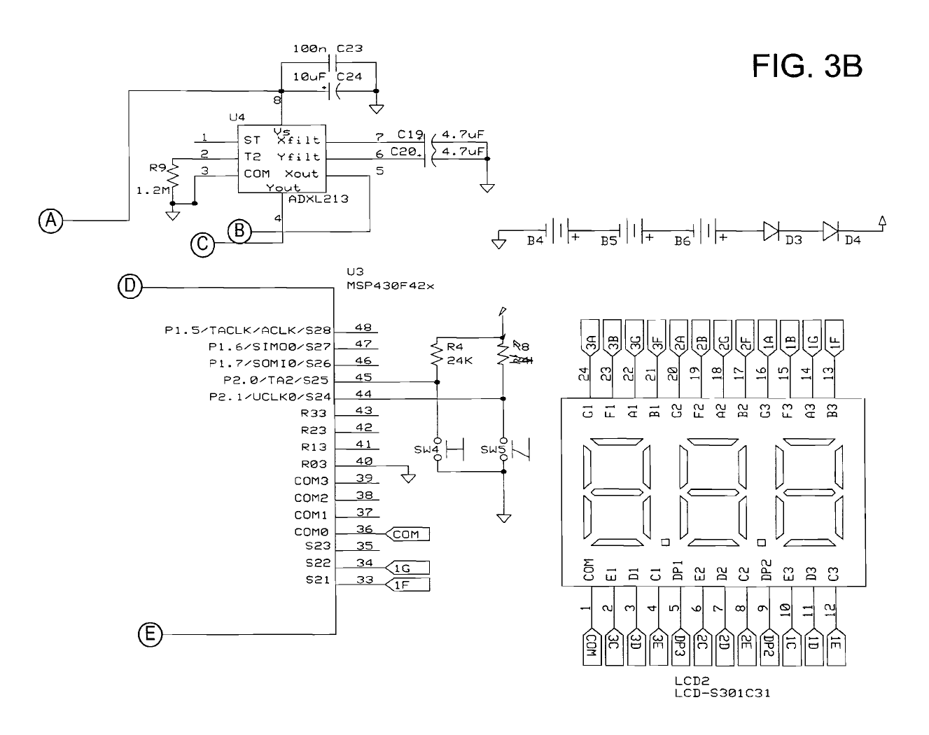

This dual axis accelerometer 28 (in FIG. 3) may be used as shown with a MSP430F42 integrated circuit and LCD readout 32 (or with other suitable components) to provide the described functionality.

Housing 13 should be a suitably sturdy material to maintain its shape and the square relationship between the bottom 26 and sides 20 and 24. Various plastics could be used, as can suitable metals, including aluminum, steel and metal alloys (provided that magnets mounted in such material can function as described temporarily to secure the housing 13 to a ferromagnetic surface). While housing 13 can be various sizes and shapes, certain ranges of sizes and shapes are preferable.

One of the more common uses of the apparatus of this invention will be in setting the angle of a table saw blade relative to the saw table top. Many such saws utilize blades ten inches in diameter, providing a maximum distance of less than 5 inches between the blade teeth and the blade arbor. A full one-half of the blade does not however, project through the table saw table top, and the unobstructed area of blade plate may be further reduced by the blade teeth and a disk-shaped blade stabilizer positioned on the saw arbor beside the blade. Because it is desirable for the apparatus 10 to mount, using one of the magnets 22, squarely against the blade plate, the size of the sides 20 and 24 needs to be relatively small in width and height. The side 20 and 24 height should be at most about four inches, preferable no more than three inches and most preferable no more than about two and one-quarter inches. Smaller sizes are also possible in the exemplary embodiment illustrated in the drawings, the dimensions “x” and “y” (width and height) can be about two and one-forth inches, and the depth “z” can be about one and one-fourth inch.

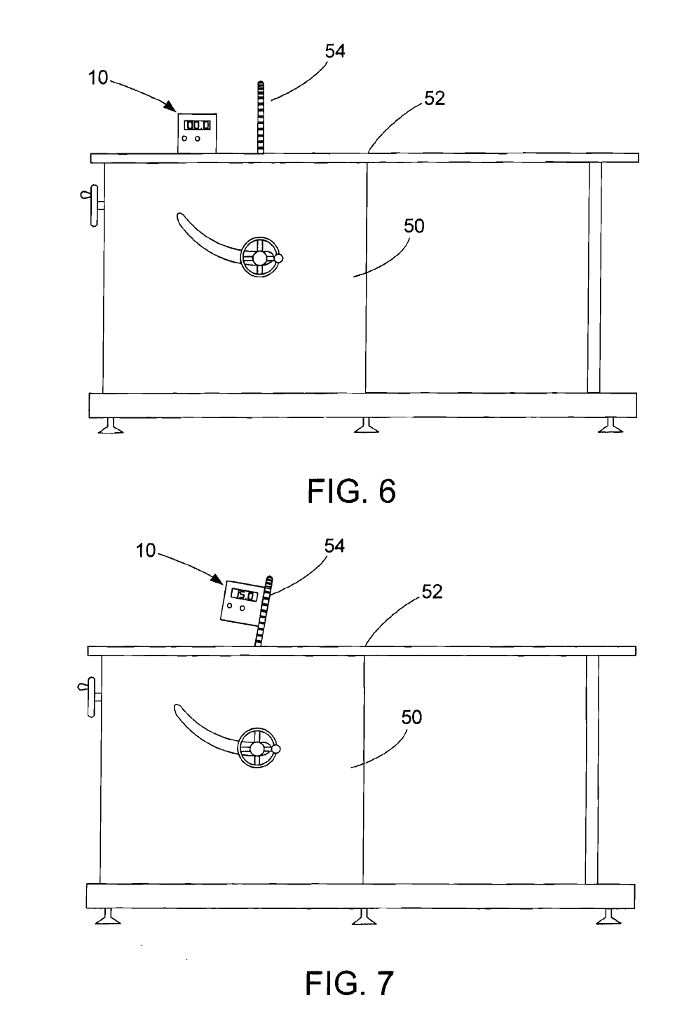

Angle reading and setting apparatus 10 is used by positioning it at a desired “zero” position such as resting on a table saw 50 horizontal table top 52 (FIG. 6) or on a jointer table. After turning apparatus 10 “on” by pressing the “on/off” button 12, the “zero” button 14 is pushed to “zero” the unit, making it read “0” degrees in display window 16. The unit can then be attached to the saw blade 54 (FIGS. 6 and 7) or other reference surface such as a jointer fence using one of the magnets (or, if it is already so attached, that surface can be tilted) and the angle of tilt will be displayed in display window 16. The “angle of tilt” displayed on the readout may actually be the deviation from 90° relative to the table top because, by convention, a blade square to the table top is said to have “0° tilt.”

As will be understood by those skilled in the art, the angle device 7 of this invention can also be used in a variety of other situations to determine the relative angles of reference surfaces or to set such surfaces at desired angles. It can be used, for example, in setting the tilt angle of a motorized miter box or “chop” saw or of a jointer fence.

As will also be understood by those skilled in the art, numerous variations and modifications of the components described above and of the described configurations of components, can be used without departing from the scope or spirit of this invention or the claims set forth below. For instance, magnets 22 could also be mounted in the top and bottom of the housing 13 to make it possible to position the device 10 more solidly on horizontal ferromagnetic support surfaces (like cast iron woodworking machinery) tables and, if desired, against the underside of horizontal ferromagnetic surfaces. Similarly, other position sensing devices and other switch configurations and apparatus circuitry could also be used. Indeed, some or all of the circuitry, including the controls and readout, could be positioned in a housing separate from (but electronically linked to) a position-sensing unit containing the accelerometer (or its functional equivalent) and one or more magnets for securing the position-sensing unit against ferromagnetic surfaces in order to make angle readings.

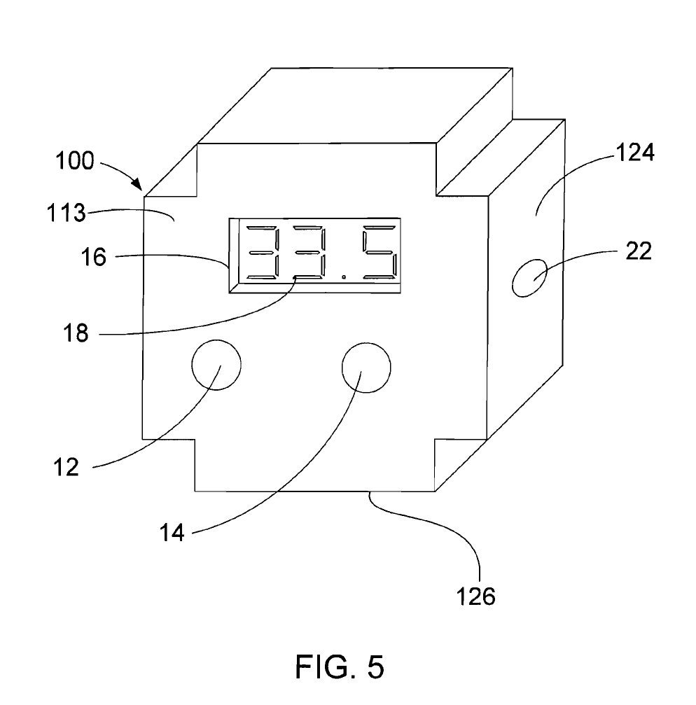

Furthermore, the sides 20 and 24 of housing 13 in the embodiment depicted in the drawings are rectangular and flat; however, other shapes are also usable provided that an appropriate registration surface is provided for contact with a ferromagnetic surface when securing the housing 13 to that surface during use. As an example, housing 113 for apparatus 100 illustrated in FIG. 5 has a cruciform shape but still has a side registration surface 124 that is square or orthogonal to bottom 126.

1. An angle setting and reading apparatus, comprising:
a. a housing having a generally planar bottom and at least one side square to the bottom,
b. at least one magnet mounted in the housing for temporarily securing the housing to a ferromagnetic surface,
c. electronic circuitry within the housing for sensing changes in the position of the housing, and
d. a display coupled to the circuitry for visually indicating changes in the position of the housing.

2. The angle setting and reading apparatus of claim 1, wherein the housing has two opposed sides, each of which is square to the bottom and the at least one magnet comprises two magnets, one of which is mounted in each side.

3. The angle setting and reading apparatus of claim 2, wherein the display is mounted in the housing.

4. The angle setting and reading apparatus of claim 2, further comprising a first control for activating the circuitry and a second control for setting the display to read “zero.”

5. The angle setting and reading apparatus of claim 2, wherein the housing is machined from aluminum.

6. The angle setting and reading apparatus of claim 2, wherein the housing comprises plastic.

7. The angle setting and reading apparatus of claim 2, wherein the housing is approximately the same height and width.

8. The angle setting and reading apparatus of claim 2, wherein the housing is no taller than approximately two and one-quarter inches.

9. The angle setting and reading apparatus of claim 2, wherein the housing is no deeper than approximately one and one-quarter inches.

10. An enclosure for an angle setting and reading apparatus comprising an electronic position sensor, a display for indicating position of the sensor and electronic circuitry for operating the sensor and display, the enclosure comprising:
a. a housing having a planar bottom and two opposed planar sides perpendicular to the bottom, and
b. at least one magnet secured in each side for securing the housing to planar ferromagnetic surface, alternatively contacting the planar ferromagnetic surface with one or the other of the two housing sides.

11. The enclosure of claim 10, further comprising a back for attachment to the housing to close a space within the housing.

12. The enclosure of claim 5, wherein the housing further comprises a front penetrated by at least a first opening for viewing the display and at a second opening through which a portion of the control may protrude.

13. An angle setting and reading apparatus, comprising:
a. a housing having a generally planar bottom and two opposed sides, each of which sides is square to the bottom,
b. at least one magnet mounted in each of the sides for temporarily securing the housing to a ferromagnetic surface,
c. battery powered circuitry within the housing for sensing changes in the tilt of the housing,
d. a display mounted to the housing and connected to the circuitry for visually indicating changes in the tilt of the housing sensed by the circuitry in degrees or fractions of degrees, and
e. a control for setting the display to read “zero.”

14. The angle setting and reading apparatus of claim 13, further comprising a second control for turning the circuitry on.

15. The angle setting and reading apparatus of claim 13, wherein each side is no more than about two and one-fourth inches tall and one and one-fourth inches wide.

16. An angle setting and reading apparatus, comprising:
a. a housing,
b. at least one magnet mounted in the housing for temporarily securing the housing to a ferromagnetic surface,
c. electronic circuitry within the housing for sensing changes in the position of the housing, and
d. a display coupled to the circuitry for visually indicating changes in the position of the housing.

17. The angle setting and reading apparatus of claim 16, wherein the at least one magnet comprises two magnets.

18. The angle setting and reading apparatus of claim 16, wherein the display is mounted in the housing.

19. The angle setting and reading apparatus of claim 16, further comprising a first control for activating the circuitry and a second control for setting the display to read “zero.”

20. The angle setting and reading apparatus of claim 16, wherein the housing is aluminum.

21. The angle setting and reading apparatus of claim 16, wherein the housing comprises plastic.

22. The angle setting and reading apparatus of claim 16, wherein the housing is approximately the same height and width.

23. The angle setting and reading apparatus of claim 16, wherein the housing is no taller than approximately two and one-quarter inches.

24. The angle setting and reading apparatus of claim 16, wherein the housing is no deeper than approximately one and one-quarter inches.

25. An enclosure for an angle setting and reading apparatus, the apparatus comprising an electronic position sensor, a display for indicating position of the sensor and electronic circuitry for operating the sensor and display, the enclosure comprising:
a. a housing comprising:
i. a bottom,
ii. a top,
iii. two opposed sides generally perpendicular to the bottom,
iv. a first opening through which a display may be viewed,
v. two openings for push-button controls, and
vi. a back opening through which a battery may be installed or removed,
b. at least one magnet secured in the housing for securing the housing to a ferromagnetic surface.

26. The enclosure of claim 25, further comprising a back for attachment to the housing to close a space within the housing.

27. The enclosure of claim 20, wherein the housing further comprises a front penetrated by at least a first opening for viewing the display and at a second opening through which a portion of the control may protrude.

28. An angle setting and reading apparatus, comprising:
a. a housing having a bottom having a bottom surface,
b. at least one magnet mounted in the bottom for temporarily securing the housing to a ferromagnetic surface,
c. battery powered circuitry within the housing for sensing changes in the tilt of the housing,
d. a display mounted in the housing and connected to the circuitry for visually indicating in degrees changes in the tilt of the housing sensed by the circuitry, and
e. a control for setting the display to read a predetermined reading.

29. The angle setting and reading apparatus of claim 28, further comprising a second control for turning the circuitry on.

30. The angle setting and reading apparatus of claim 29, wherein each side is no more than about two and one-fourth inches tall and one and one-fourth inches wide.

31. The angle setting and reading apparatus of claim 30, wherein:
a. the housing is aluminum and has a window through which readout numerals may be seen,
b. the battery is positioned within the housing and is accessible by removing a housing back, and
c. the at least one magnet comprises a round rare earth magnet mounted not flush with the bottom surface.

32. A method for determining the relative angular position of two machine surfaces, the method comprising:
a. providing a self-contained angle reading apparatus comprising a housing having an outside surface and a magnet secured to the housing proximate the outside surface, and, in the housing, angular position-determining circuitry and a display for displaying numerals indicative of angular position,
b. positioning the angle reading apparatus on one of the two machine surfaces, and
c. noting a first numeral displayed by the display, and
d. temporarily securing the angle reading apparatus to the other of the two machine surfaces with the magnet and noting another numeral displayed by the display.

33. The method of claim 32, wherein the angle reading apparatus further comprises a “zero” control for causing the numeral display to display a pre-determined numeral, and the method further comprises, after positioning the angle reading apparatus on the one of the two machine surfaces:
actuating the control to cause the angle reading apparatus to display the pre-determined numeral, so that the first numeral displayed by the display is the predetermined numeral.

34. The method of claim 33 further comprising:
e. while the angle reading apparatus remains temporarily secured to the other of the two machine surfaces, adjusting the position of the other machine surface until a numeral appears in the display indicating a desired angular position.

35. The method of claim 34, wherein the machine comprises a table saw and the machine surfaces comprise a table top surface and a circular saw blade side surface, and step (b) of the method further comprises positioning the apparatus on the table top surface, and step (d) of the method further comprises temporarily securing the angle reading apparatus to the circular saw blade side surface.
